(19) United States
(12) Patent Application Publication
(10) Pub. No.: US 2010/0327591 A1
(43) Pub. Date: Dec. 30, 2010

(54) Kinetic Energy Recovery Turbine

(75) Inventors: Georges P. Dick, Outremont (CA); Marie-Helene Briand, Quebec (CA); Imad A. Hamad, Quebec (CA)

Correspondence Address: Sunstein Kann Murphy & Timbers LLP, 125 SUMMER STREET, BOSTON, MA, 02110-1618, US

(73) Assignee: RSW INC., Montreal, Quebec (CA)

(21) Appl. No.: 12/808,963

(22) PCT Filed: Dec. 22, 2008
(86) PCT No.: PCT/CA2008/002263

§ 371 Date: Sep. 16, 2010

Related U.S. Application Data
(60) Provisional application No. 61/015,400, filed on Dec. 20, 2007.

(51) Int. Cl. F03B 13/10; H02K 7/18

(52) U.S. Cl. 290/52

(57) ABSTRACT

The invention consists of developing an environmentally friendly new energy converter using light weight material. The energy converter shall be fully submersed in running undercurrents waters and have high overall efficiency ratio. The energy converter consists of, among other things, eliminating the in-line electric generator and substitute it with peripheral electro-magnetic coupling device, attached to the runner tip from inside and surrounding the energy converter housing from outside. The energy converter electric brushless circuits and winding must be totally sealed from water, using new sealing techniques and shall be also electrically isolated as well. The energy converter allows extracting energies from undercurrents with large frequency and voltage ranges.

### FIELD OF THE INVENTION

The present invention relates to electric generation systems and to components for energy conversion while submerged in water and for extraction of energy from below surface currents with conversion to an electrical current.

### BACKGROUND OF THE INVENTION

Energy extraction and conversion under water is known: for example, U.S. Pat. Nos. 6,168,373; 6,139,255; and WO-02-27151. However, existing technologies are not satisfactory for economical and environmentally sound and sustainable energy extraction.

Thus, developments that allow such energy extractions which are economical and is an environmentally sound and sustainable approach are desirable.

### SUMMARY OF THE INVENTION

An object of the present invention is to provide a turbine for submersion in water, the turbine comprising a flower having an inlet, an outlet, an inner surface and outer surface; a rotor assembly adapted for converting kinetic energy from water flow into rotational energy, the rotor assembly comprising a runner, a plurality of blades coupled to a first end of the runner and a magnet enclosed within a second end of the runner, the second end of the runner facing the inner surface of the flower; a fixed stator assembly located at the inner surface of the housing, said stator comprising an electrical circuit and being substantially aligned with said magnet and said stator being water isolated; and a power collector device for facilitating the flow of electrical current from the stator assembly to an external current sink, the power collector device being coupled to the stator.

In one embodiment of the present invention, the turbine further comprises at least one cavity provided between the outer surface and the inner surface of the flower, the cavity being adapted for being filled with a fluid, thereby stabilizing the turbine beneath the water surface. The fluid used can be air, water, or any other fluid suitable for such an application, which would be easily understood by the person skilled in the art.

In one embodiment of the present invention, the inlet and outlet of the housing have a venturi flow restriction for accelerating flow to the rotor assembly.

In one embodiment of the present invention, the housing have at least one fluid separation eliminator device fixed thereto near the outlet, the device being adapted for controlling the vortex formed at the outlet of the housing. The fluid separation eliminator device can be a rib, but can be also of any other nature that will allow to achieve the desired result.

In one embodiment of the present invention, the turbine further comprises an equilibrium shaft extending along the central longitudinal axis of the house, the shaft being connected to the inner surface of the housing by a plurality of stay-vanes brackets and bearings, the stay-vanes brackets being located perpendicularly to the central longitudinal axis of the housing.

The invention consists of a new Energy Converter (“EC”), fully submersed in under surface waters running currents. Built using lightweight materials. The EC has high overall efficiency ratio. The EC energy consists of, among other things, eliminating the in-line electric generator and substitute it with peripheral electro-magnetic coupling device, which is water tight and insulated, the rotor is attached to the runner tips from inside the EC housing and surrounding it from outside. The EC electric circuits and winding are fully sealed from water. In one embodiment, this is achieved using stainless steel alloys and sealing techniques isolating the electrical generator circuit from water. The EC comprises in another embodiment electric brushless circuits and windings sealed from water, which are also electrically isolated. The EC allows extraction of energy from undercurrents with large frequency and voltage ranges. In one embodiment, the present invention is directed to extraction of Kinetic energy from river body undercurrents, including with zero head.

### BRIEF DESCRIPTION OF THE DRAWINGS

Further aspects and advantages of the present invention will become better understood with reference to the description in association with the accompanying drawings in which:

FIG. 1 is a cross sectional view of one embodiment of the turbine of the present invention;

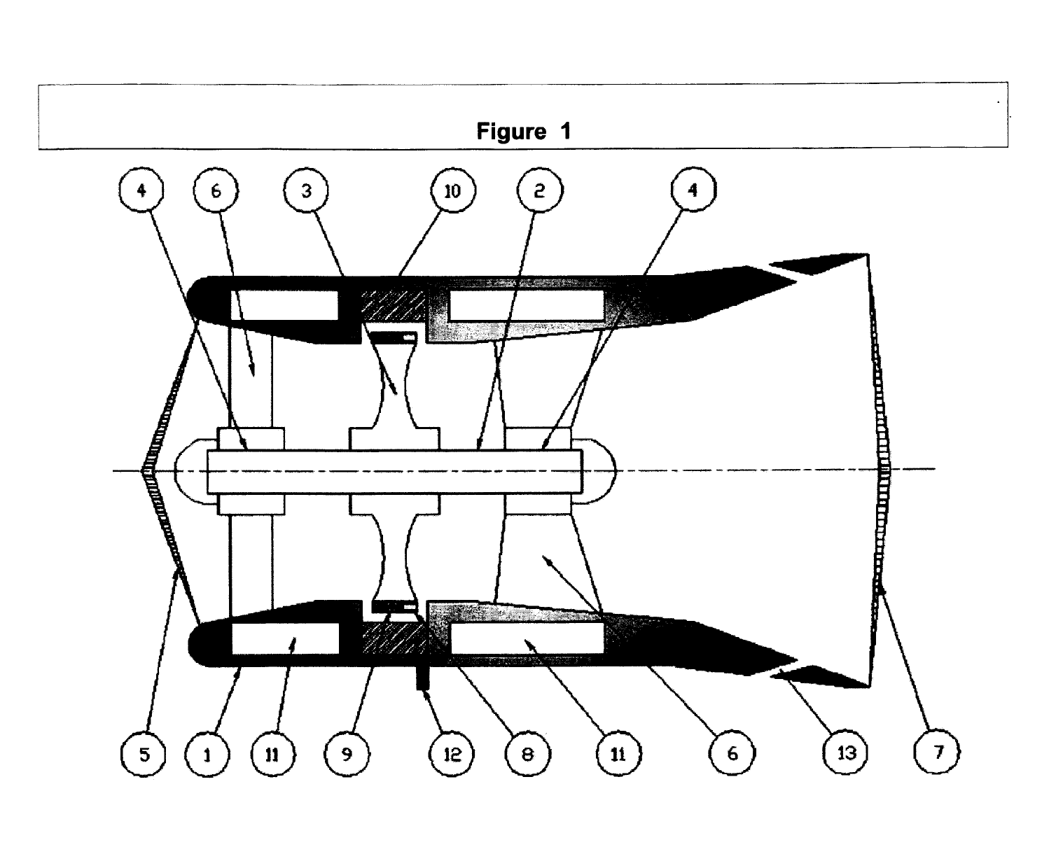

FIG. 2 illustrates the water sealing on the rotor head and the stator in one embodiment of the turbine of the present invention;

FIG. 3 illustrates an electrical circuit used in one embodiment of the present invention;

FIG. 4 illustrates an electrical circuit used in a further embodiment of the present invention;

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

An environmentally friendly non-invasive Energy Converter (EC) allowing extracting and converting into electricity, kinetic energy contained in under surface running water currents, at affordable kWh price.

The concept allows single or multiple EC assemblies as stand alone producing energy to isolated grids and/or synchronized to existing utilities grids.

### MAJOR COMPONENTS IDENTIFICATION

The EC is made of:
(1) Flow Enhancer Housing
(2) Equilibrium Shaft Bearings
(3) Light weight runner,
(4) Auto-balanced bearings
(5) Inlet guard
(6) Stay-vanes brackets and bearings support
(7) Outlet guard
(8) Magnet
(9) Electric generator rotor
(10) Fixed stator
(11) Floater
(12) Collector
(13) Fluid separation eliminator

### Detailed System Operation:

### Creating a Favorable Environment for Kinetic Energy Conversion

The present invention allows single or multiple EC assemblies as stand alone and/or synchronized to existing utilities grids. The EC is made of a housing (1) with an equilibrium shaft bearings (2) a light weight runner (3), auto-balanced bearings (4), intake guard (5), stay-vanes brackets and bearings (6), guard-out-take (7), a rotating exciter (8), electric generator rotor (9), stator (10), floater (11) and collector (12). The equilibrium shaft allows balancing the loads and stabilize the runner.

The fluids flow in the machine from the intake-guard (5) and leave from out-take guard (7). The lightweight runner (3) is directly coupled with the electric generator rotor (9) that is self contained with the exciter (8). The fluid separation eliminator (13) is embedded in the housing (1).

The EC is placed in the under surface running water currents. In order to maximize the flow across the EC housing and increase the fluid velocity, the EC housing (1) is shaped as a venture in a way to create a negative pressure downstream at its outlet (7) versus the pressure upstream at its inlet (5). This negative pressure is caused by the difference in diameters between the inlet and the outlet and the shape given to the EC housing between the inlet and outlet. The fluid flow around the outlet edges causes this negative pressure inside the outlet and consequently draws up the fluid and accelerating it at the throat or center of the EC converter where the lightweight runner is located, while eliminating the fluid separation at the outlet (7) using fluid separation eliminator (13).

The invention incorporates a double empty shell housing which allows the EC to have some degree of floating.

Other energy conversion products use light material to reach the same goal at the detriment of rigidity and useful life expectancy.

Other energy conversion products are heavier than water and require mast or tripod to locate them at their operating point. The invention of the EC that floats in mid water at a fixed depth and is fastened with a concrete or similar heavy material anchored that relies also on friction to maintain the EC in place. This allows to remove the invention from the river easily for maintenance or relocate it at another site. Similar energy conversion products on the market requires expensive mast or pillar to achieve the same or a complicated combination.

The fluid separation eliminator (13) are designed and fixed on the EC housing, providing it with both mechanical stiffness and flow and vortex controls. In a preferred embodiment of the present invention, it has the shape of a rib. However, one skilled in the art would understand that other shapes could be used in order to obtain the same desired result.

In order to enhance the hydraulic forces efficiency and optimize the portion of the kinetic energy contained in the water currents and transfer it to the light weight runner blades, a fixed pre-shaped stay vanes and brackets (6) are used, for at least, three following purposes:
a) Swirl and Orient the fluid in such a way it enters the light weight runner as parallel as possible to the attack edge of the blades;
b) Provide support for the equilibrium shaft bearings;
c) Enhance the EC stiffness and resistance to buckling, deflection and deformation.
   Conversion of Hydraulic Kinetic Energy into Electrical Energy:

The EC transforms running waters kinetic energy into electrical energy that is transmitted to existing interconnected and/or isolated electrical grids.

As the water enters the EC at (5) and leaves at (7), it transfers a fraction of its flow kinetic energy to the lightweight runner blades. The transferred kinetic energy is resulting from the hydraulic forces contained in the flow and crossing between the runner blades. The integration of the hydraulic individual forces on the entire effective blade surfaces and, taken into account the spatial distribution with respect to the centerline of the EC, result in a mechanical torque at the centerline of the light weight runner (3).

Instead of transferring this mechanical torque to an in-line electrical generator, directly through mechanical coupling or indirectly through a speed increaser and or any other coupling system, the EC invention, instead, it transfers the mechanical torque generated by the runner blades from its center equilibrium shaft (2) to its outer ring (8) and (9), as mechanical force, perpendicular to the EC centerline and tangent to the outer circumference of the rotor (8) and (9). This mechanical force is equally split between the rotor individual permanent magnet elements (9) and used to generate the relative movement between the rotor rotating field (9) and the stator fixed electrical circuit (10).

The rotor permanent magnets (9) generate and carry a fixed electro-magnetic field (fixed with respect to the runner), but rotating with it at the same revolving speed.

This rotating magnetic filed is generated by the rotor permanent magnets or the rotating exciter (8), fixed in encapsulated stainless steel housings and fully isolated with an isolation media from water and protect the permanent magnets and/or exciter against corrosion. These encapsulated permanent magnets and/or rotating exciter (8) are embedded in the rotor body and rotating at the same revolving speed as the runner.

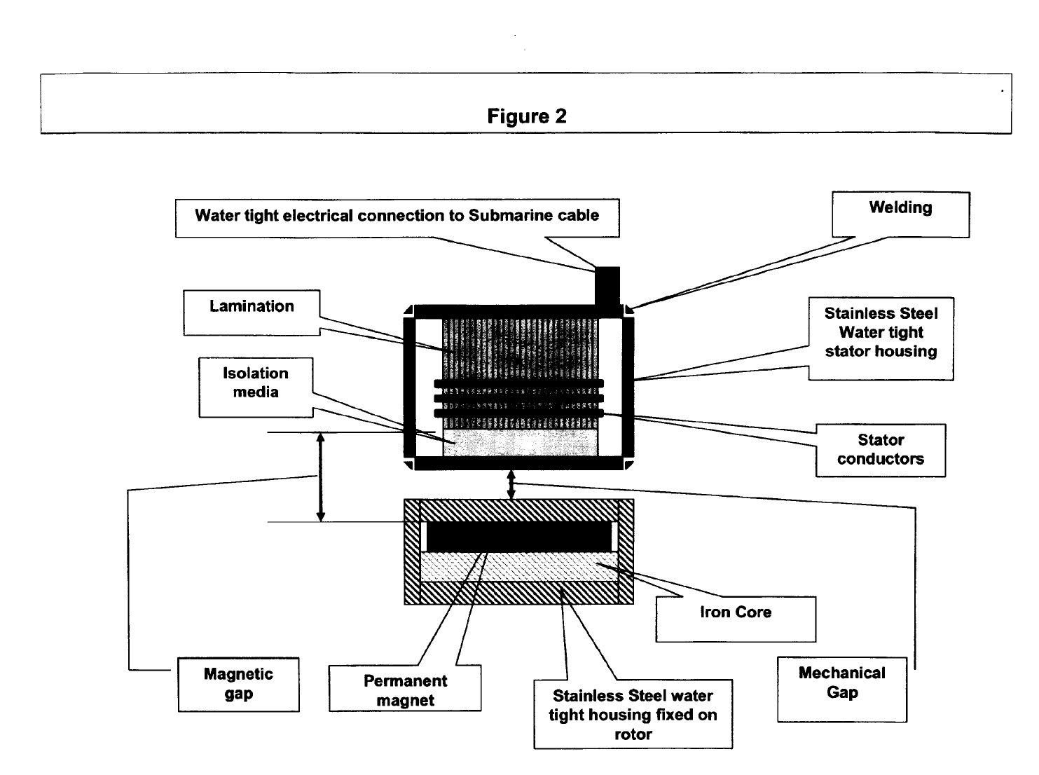

In the EC concept, the stator is fully enclosed and sealed from water using a stainless steel housing as illustrated in FIG. 2.

Although the EC is totally submersed in the water currents, its rotor (9) and stator (10) are totally enclosed and electrically isolated from water.

The stator circuit is connected to the electrical cabinets onshore, through a sub-marine type cable, carrying the electrical power and signals from and to the EC.

The EC produces energy at various frequencies and voltages sufficient enough to be sent indirectly through insulated gates bipolar transistor (IGBT) to the grid as described in the figure number 3, detailed in the Electrical Control System Circuit Description:

### Mechanical Features of the EC

The equilibrium shaft (2) is designed to allow balancing the loads generated by the runner such as, Thrust and Radial Loads and, stabilize the runner by providing adequate dynamic mechanical gap between the rotor and the stator for the entire operating envelops conditions.

The static and dynamic loads are supported by radial and axial bearings with self-contained and auto lubricated with environmentally safe lubricant media.

The equilibrium shaft (2) is designed in order to enhance stiffness and reduce weight.

The EC housing (1) is made of double layers, lightweight material in order to achieve the following objectives:
i) Enhance stiffness
ii) Reduce weight
iii) Assist floatability of the entire assembly

The EC housing has many attachments (rigging legs) designed to interface with concrete blocs and or similar anchoring techniques. The concrete blocs are resting on the bottom of the water and holding the EC in place. The front end of the concrete bloc is hydro dynamically designed to reduce drag forces on the entire EC and its anchoring techniques.

The EC housing (1) has a surrounding floater (11) designed to allow certain degree of upward floatability of the entire EC. The attachments to the bottom concrete blocs, force to EC downward where floatability feature pulls it upward, maintaining the EC balanced in place. Side attachments are also provided to ensure straightness of the EC with respect to the water flow stream.

### 3. Detailed Description Trek—Electrical Circuit

The EC electrical circuit, downstream of the electrical generator, is comprised from:
Isolated Gate Bipolar Transistor (IGBT)
DC Bus bar
Low voltage circuit breaker and surge
Input reactance and sin and harmonic filter
Isolation input transformer
PLC Control system and software
MCC including control and monitoring relays
Power supply
Disconnect switches, fuses and all required accessories for safe operation

The IGBT collects the energy coming out of the submersed EC, via the marine type cable and rectifies the signal from AC into DC and feeds it to a DC bus bar. All parallel EC's are feeding energy into the grid; either through their own stand alone inverters and or through common inverter. All EC have their own protection systems, installed onshore in the MCC's.

The EC in one embodiment produces energy at various frequencies and voltages between 1 and 100 Hz and voltage sufficient enough to be sent to the grid, through the IGBT as well as the step-up transformers.

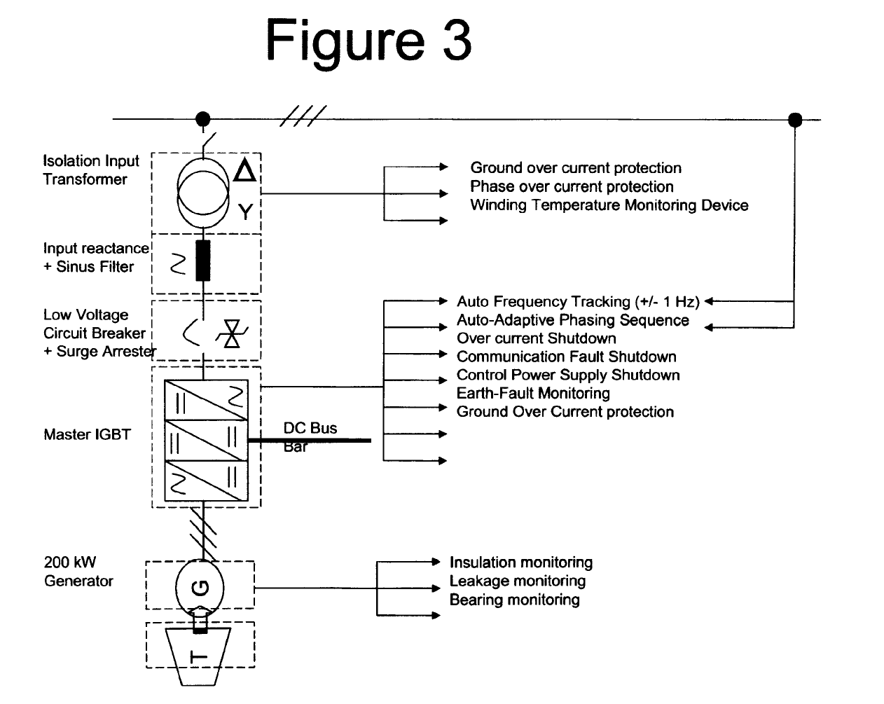

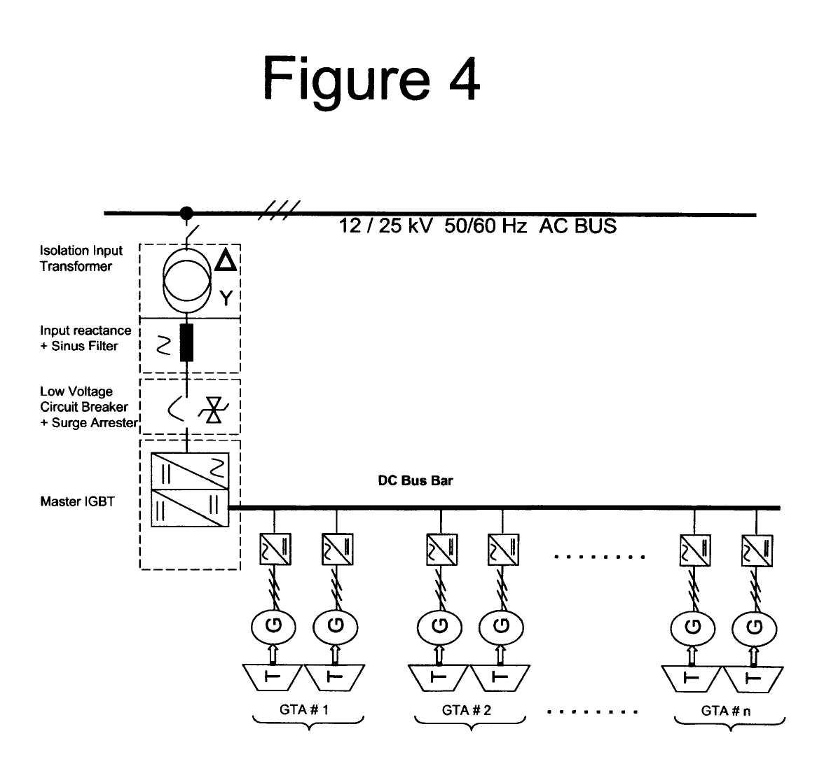

The inverter synchronizing the AC with grid feedback for frequency, voltage and phase synchronization. Examples of electrical circuits for such purpose are according to FIGS. 3 and 4 hereafter.

### 4. Advantages and Benefits

The overall weight and bulkiness of the EC is dramatically reduced
The EC provides light weight runner
The EC has a light shaft
The EC eliminates the in-line speed increaser
The EC eliminates the conventional mechanical coupling between the runner and the electrical generator
The EC eliminates the in-line Electrical Generator
The EC has a novel fully submersed and fully water tight sealed housing, isolating the entire stator from water, while preserving its electromagnetic coupling efficiency with rotor permanent rotating magnetic field
The EC enhances the flow across the housing and increases the pressure drop between the inlet and the outlet.
The EC does not require secondary control on the runner blades or the stay vanes
The EC does not require mast, tripod or pillar
The EC allows producing electrical energy at variable frequencies maximizing the overall efficiency
The EC allows producing electrical energy at voltage and frequency different from the grid bus while synchronizing to the grid, through IGB,T with proper frequency, voltage and phase
The operation of the EC does not generate green house gases
The EC allows simultaneous groups operation with or without existing grids
The EC allows floating the energy converter without ballast control
The EC allows extracting renewable energies at affordable price per kWh
Reduces the manufacturing cost per kWh
The EC enhances reliability and reduces maintenance cost
The EC is transportable and can be relocated without requiring demolishing or large civil engineering
The EC does not require expensive tripods, mast, or pillars to be located or lifter to surface.

1. A turbine for submersion in water, said turbine comprising:
a flow enhancer housing having an inlet, an outlet, an inner surface and an outer surface as well as lateral pressure counterbalancing openings;
a central shaft extending along a central longitudinal axis of said flow enhancer housing;
a first plurality of stay-vanes connecting the central shaft to the housing at the inlet;
a rotor assembly connected to the central shaft and adapted for converting kinetic energy from water flow into rotational mechanical energy, said rotor assembly comprising a runner, a plurality of profiled blades coupled to a first end of said runner and a magnetic rotor field enclosed within a second end of said runner, said second end of said runner facing the inner surface of said flow enhancer housing and stator;
a second plurality of stay-vanes connecting the central shaft to the housing downstream of the rotor assembly;
a fixed stator assembly disposed between said inner surface and said outer surface of said housing, thereby being water insulated, said stator comprising an electrical circuit and being aligned with said magnetic rotor field; and
a power collector system coupled to said stator for drawing produced electrical energy from the stator assembly.

2. The turbine of claim 1, wherein the central shaft is an equilibrium shaft extending along the central longitudinal axis of said housing, said equilibrium shaft being supported by auto-balanced bearings mounted between the first plurality of stay-vanes and the shaft and also between the second plurality of stay-vanes and the shaft.

3. The turbine of claim 1, wherein the stator is disposed radially with respect to the magnetic field.

4. The turbine of claim 1, wherein the magnetic field and stator are each oriented to have a longest dimension parallel to the shaft.

5. The turbine of claim 1, wherein the stay-vanes are oriented to pre-swirl the water flowing into the turbine such that the water is oriented according to the blade profile to maximize efficiency while also providing bearing support and enhancing overall structural stiffness of the turbine.

6. The turbine of claim 1, wherein said inlet and outlet have a venturi flow enhancing profile for accelerating mass flow to said rotor assembly.

7. The turbine of claim 1, wherein said housing has at least one fluid separation eliminator disposed downstream of the second plurality of stay-vanes near the outlet, said eliminator being adapted for attenuating a vortex forming at the outlet of said housing while avoiding fluid separation.

8. The turbine of claim 7, wherein said fluid separation eliminator comprises a plurality of openings acting as pressure counterbalancing means.

9. The turbine of claim 1, wherein said housing is made of lightweight material.

10. The turbine of claim 1, wherein the inlet comprises a converging section and wherein the outlet comprises a diverging section.
